(19) United States
(12) Patent Application Publication
(10) Pub. No.: US 2018/0375672 A1
(43) Pub. Date: Dec. 27, 2018

(54) POWER OF ETHERNET POWER AND DATA SPLITTING SYSTEMS AND METHODS

(71) Applicants: Jean-Michel Thiers, Sunnyvale, CA (US); Milko Kirov Rizanov, Sofia (BG)

(72) Inventors: Jean-Michel Thiers, Sunnyvale, CA (US); Milko Kirov Rizanov, Sofia (BG)

(21) Appl. No.: 15/632,385

(22) Filed: Jun. 25, 2017

(51) Int. Cl. H04L 12/10; H04L 12/40

(52) U.S. Cl. CPC H04L 12/10; H04L 12/28; H04L 12/40045; H04L 12/40006

(57) ABSTRACT

The disclosure includes an electronic system that receives data and power from an Ethernet cable and splits the data and the power. The system can include a housing and an input port coupled to the housing. The input port can be arranged and configured to receive the Ethernet cable that transmits the data and the power. The system can also include a splitter circuit located along an internal portion of the housing. The splitter circuit can be arranged and configured to receive the data and the power from the Ethernet cable and thereby split the data from the power. The splitter circuit can include at least one capacitor arranged and configured to block power; and an electrical component having an impedance arranged and configured to block data.

### BACKGROUND

### Field

The present disclosure relates generally to electronic devices and, more particularly to a connector for an electric power and data transmission cable such as Ethernet cables using power over Ethernet (PoE) technology.

### Description of Related Art

Many electronic devices use both power and data to function. It is very convenient to transfer power and data over one cable. To achieve this, power over Ethernet (PoE) technology is used in an Ethernet cable. Power over Ethernet (PoE) describes any system that passes electric power along with data on twisted pair of Ethernet cabling. This allows a single cable to provide both data signal and electric power to devices. Often, before connecting to electronic devices, the power and data signal must be separated into separate wires to be utilized by the device. To output the DC power and data signal on individual wires, a PoE splitter may be used.

In prior art PoE splitting systems, a power sourcing equipment (PSE) injects DC power onto data on an Ethernet cable. To achieve the data blocking and power blocking, PoE splitting systems commonly use an inductor or transformer. The inductively coupled coils transfer the high-frequency data signal but blocks out the low-frequency DC power. The DC-to-DC converter transfers the DC power but blocks the data frequency.

### SUMMARY

The present disclosure includes an electronic system that receives data and power from an Ethernet cable and splits the data and the power. The system can include a housing and an input port coupled to the housing. The input port can be arranged and configured to receive the Ethernet cable that transmits the data and the power. The system can also include a splitter circuit located along an internal portion of the housing. The splitter circuit can be arranged and configured to receive the data and the power from the Ethernet cable and thereby split the data from the power. The splitter circuit can include at least one capacitor arranged and configured to block power, and an electrical component having an impedance arranged and configured to block data.

In some embodiments, the electrical component comprises at least one of a ferrite bead and an inductor. The system can thereby include at least one of an output data port located on the housing and a data cable extending from the housing. The at least one of the output data port and the data cable can be arranged and configured to receive the data from the splitter circuit and thereby transmit the data. The system can also include at least one of an output power port located on the housing and a power cable extending from the housing. The at least one of the output power port and the power cable can be arranged and configured to receive the power from the splitter circuit and thereby transmit the power.

Furthermore, in some embodiments, the at least one of the output data port and the data cable comprises the data cable. In some embodiments, the at least one of the output power port and the power cable comprises the power cable.

In some embodiments, the input port defines an RJ45 type socket and the data cable includes a first output RJ45 plug located opposite the housing. The electronic system can further comprise a data adapter cable including a first end having an RJ45 socket that receives the data from the first output RJ45 plug and a second end having a cable with a Universal Serial Bus (USB) plug that transmits the data.

The power cable can define an Ethernet type cable and the power cable can include a second output RJ45 plug located opposite the housing. In some embodiments, the electronic system further comprises a power adapter device including a first side having an RJ45 socket that receives the power from the second output RJ45 plug and a second side having a USB socket that transmits the power.

In some embodiments, the system further comprises a power adapter cable including a first end having a USB plug that receives the power and a second end having a lightning cable plug that transmits the power. The electronic system can further comprise a data and power adapter cable including a first end having a USB socket that receives data from the USB plug of the data adapter cable, and a lightning cable socket that can receive power from the lightning cable plug of the power adapter cable. The data and power adapter cable can include a second end having a lightning cable plug that transmits the data and power to a tablet device.

In some embodiments, both the first cable and the second cable are disposed within a cable sheath. In some embodiments, the cable sheath is the same cable sheath for both the first cable and the second cable.

Even still, in some embodiments, the at least one of the output data port and the data cable comprises the output data port, and the at least one of the output power port and the power cable comprises the output power port. The input port can define an RJ45 type socket, the output data port can define an RJ45 type socket, and the output power port can define an RJ45 type socket.

In some embodiments, the system further includes a data cable extending from the output data port. The data cable can be arranged and configured to receive the data from the splitter circuit and thereby transmit the data. The system can also include a power cable extending from the output power port. The power cable can be arranged and configured to receive the power from the splitter circuit and thereby transmit the power.

The data cable can include a first end comprising a first output RJ45 plug and a second end comprising a first input RJ45 plug electrically and mechanically coupled to the output data port. The power cable can include a first end comprising a second output RJ45 plug and a second end comprising a second input RJ45 plug electrically and mechanically coupled to the output power port.

In some embodiments, the system further includes a data adapter cable including a first end comprising an RJ45 socket that receives the data from the first output RJ45 plug and a second end having a cable with a USB plug that transmits the data. The system can also include a power adapter device including a first side having an input RJ45 socket that receives the power from the second output RJ45 plug and a second side having a USB socket that transmits the power.

Additionally, in some embodiments, the system includes a power adapter cable including a first end having a USB plug that receives the power and a second end having a lightning cable plug that transmits the power. The system can also include a data and power adapter cable including a first end having a USB socket that receives data from the USB plug of the data adapter cable, and a lightning cable socket that receives power from the lightning cable plug of the power adapter cable. The data and power adapter cable can include a second end having a lightning cable plug that transmits the data and power to a tablet device. In some embodiments, the input port is located on the housing.

The disclosure also includes a method of using an electronic system to receive data and power from an Ethernet cable and split the data and the power. Some methods include receiving, via an input port coupled to a housing, the Ethernet cable that transmits the data and the power. Methods can also include receiving, via a splitter circuit located within an internal portion of the housing, the data and the power from the Ethernet cable. Even still, methods can include blocking power, via at least one capacitor located along the splitter circuit; and blocking data, via an electrical component located along the splitter circuit, the electrical component having an impedance. Methods can include splitting, via the splitter circuit, the data from the power.

In some embodiments, the method includes transmitting, via a data cable extending from the housing, the data. Methods can even include transmitting, via a power cable extending from the housing, the power.

Methods can also include transmitting, via an output data port located on the housing, the data. As well, methods can include transmitting, via an output power port located on the housing, the power. In some embodiments, methods include reducing, via the electronic system, power loss by less than or equal to 1 Watt.

### BRIEF DESCRIPTION OF THE DRAWINGS

These and other features, aspects, and advantages are described below with reference to the drawings, which are intended to illustrate, but not to limit, the invention. In the drawings, like reference characters denote corresponding features consistently throughout similar embodiments.

FIG. 1 illustrates a PoE cable splitter for transferring power and data in separate interfaces, according to some embodiments.

FIG. 2 is an exploded perspective view of the PoE cable splitter from FIG. 1.

FIG. 3a illustrates a top view of a printed circuit board (PCB) located along an internal portion of the PoE cable splitter housing, according to some embodiments.

FIG. 3b illustrates a top view of another PCB with an alternate design for components accommodating only mode A PoE, according to some embodiments.

FIG. 4 illustrates an electrical schematic of the PCB, according to some embodiments.

FIG. 5 illustrates another electrical schematic of the PCB, according to some embodiments.

FIG. 6 illustrates a Poe cable splitter, according to some embodiments.

FIG. 7 illustrates an overview layout of one way of using the Poe cable splitter to connect an Ethernet cable with PoE to a USB connector socket in an iOS tablet.

FIG. 8 illustrates an overview layout of one way of using the Poe cable splitter to connect an Ethernet cable with PoE to a USB connector socket in an Android tablet.

FIG. 9 illustrates a method of using an electronic system to receive data and power from an Ethernet cable and split the data and the power, according to some embodiments.

### DETAILED DESCRIPTION

Although certain embodiments and examples are disclosed below, inventive subject matter extends beyond the specifically disclosed embodiments to other alternative embodiments and/or uses, and to modifications and equivalents thereof. Thus, the scope of the claims appended hereto is not limited by any of the particular embodiments described below. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain embodiments; however, the order of description should not be construed to imply that these operations are order dependent. Additionally, the structures, systems, and/or devices described herein may be embodied as integrated components or as separate components.

For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

### LIST OF REFERENCE NUMERALS

1—Electronic system (i.e. PoE cable splitter)
2—Electronic system (i.e. PoE splitter—alternate embodiment)
3—Power adapter device (e.g. Kronos PCBA)
4—Data adapter cable (e.g. RJ45 socket to USB plug cable)
5—Power adapter cable (e.g. USB to lightning cable)
6—Data and power adapter cable (e.g. Camera adapter)
7—Tablet device
10—Housing
10a—Housing top
10b—Housing bottom
20—RJ45 socket
21—RJ45 plug
30—Ethernet cable
31—Individual wires from Ethernet cable
40—PCB with surface mount parts
41—PCB
42—Insulation-displacement connectors
43—Capacitors
44—Ferrite beads
45—PCB traces

### Introduction

A transformer has power losses due to the use of coupled inductor coils. This method of splitting power and data causes power loss and lowers the effective range of the data signal. Electricity loses voltage and strength as it travels down a wire due to internal resistance of the wire. All Ethernet cables have specifications on how much voltage is lost per a specified distance of wire. Because of this, it is desired to have the least power loss and voltage loss at the source before the signal travels down the cable.

Conventional PoE cable splitters require an inductor component such as a transformer to achieve the power and data splitting. Some components even use a converter to convert the voltage level of the incoming DC power to a different voltage level. Use of these components adds cost and complexity to the PCB of the device. They also introduce additional power losses and lower the data signal's effective range over the span of the wire. Another undesired effect is that the device can only handle a lower load.

As such, there exists a need in the art for a PoE cable splitter with less power loss and less reduction in effective range of the data signal. Furthermore, there exists a need in the art for a PoE cable splitter that can handle higher loads. Finally, there exists a need in the art for a slimmer and more compact PoE cable splitter.

The deficiencies and drawbacks associated with conventional PoE cable splitters are specifically addressed and alleviated by a PoE cable splitter as disclosed herein. The PoE cable splitter may include a connector port for Ethernet cables, a PCB with various electrical components and wires. The PCB contains capacitors to block out the DC power to the wires outputting the data signal. The PCB also contains ferrite beads (with an impedance of 600 ohm or more) to block data. To block out data to the wire outputting DC power no transformer or inductively coupled parts are required.

### Power and Data Splitting Systems

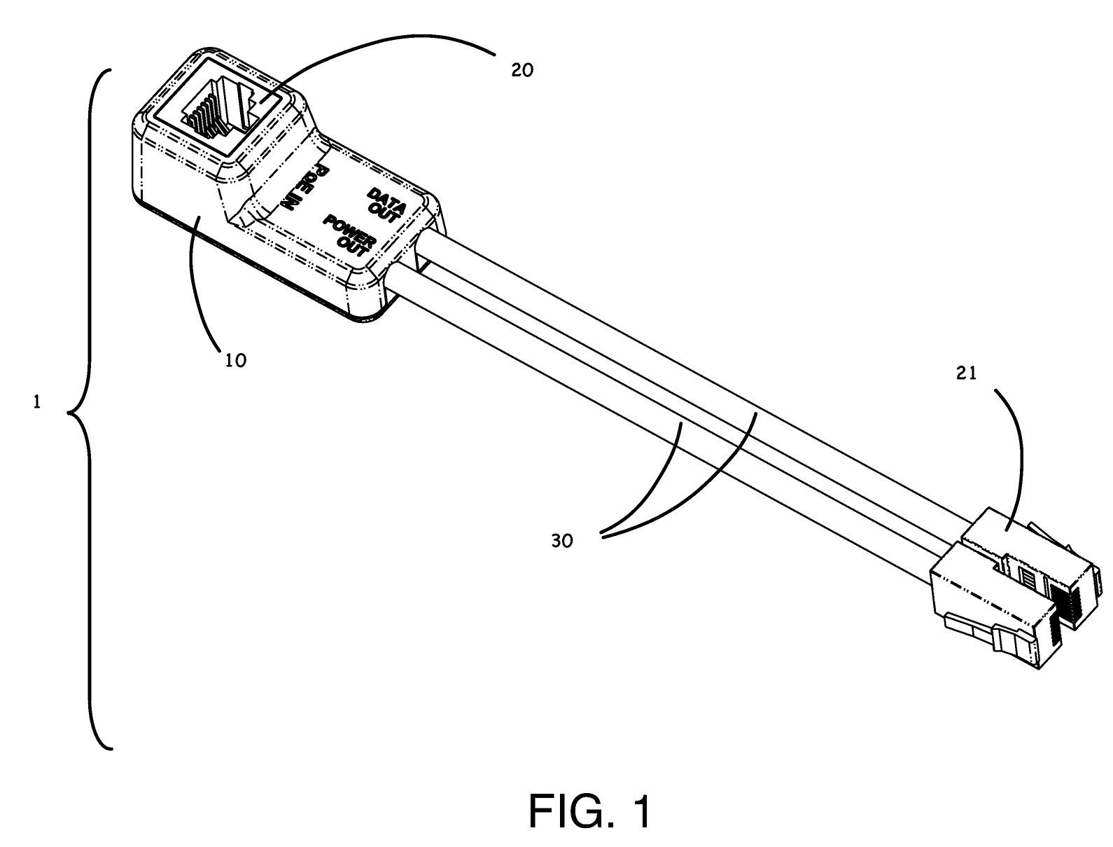

Referring now to the drawings, FIG. 1 shows the assembled electronic system 1 (e.g. PoE cable splitter) assembled for the use of transferring power and data in separate interfaces. As shown in FIG. 1, the electronic system 1 can include a housing 10 and an input port 20 coupled to the housing 10. The input port 20 can be arranged and configured to receive the Ethernet cable that transmits the data and the power. It should be appreciated that the term “coupled” includes both directly coupled and indirectly coupled.

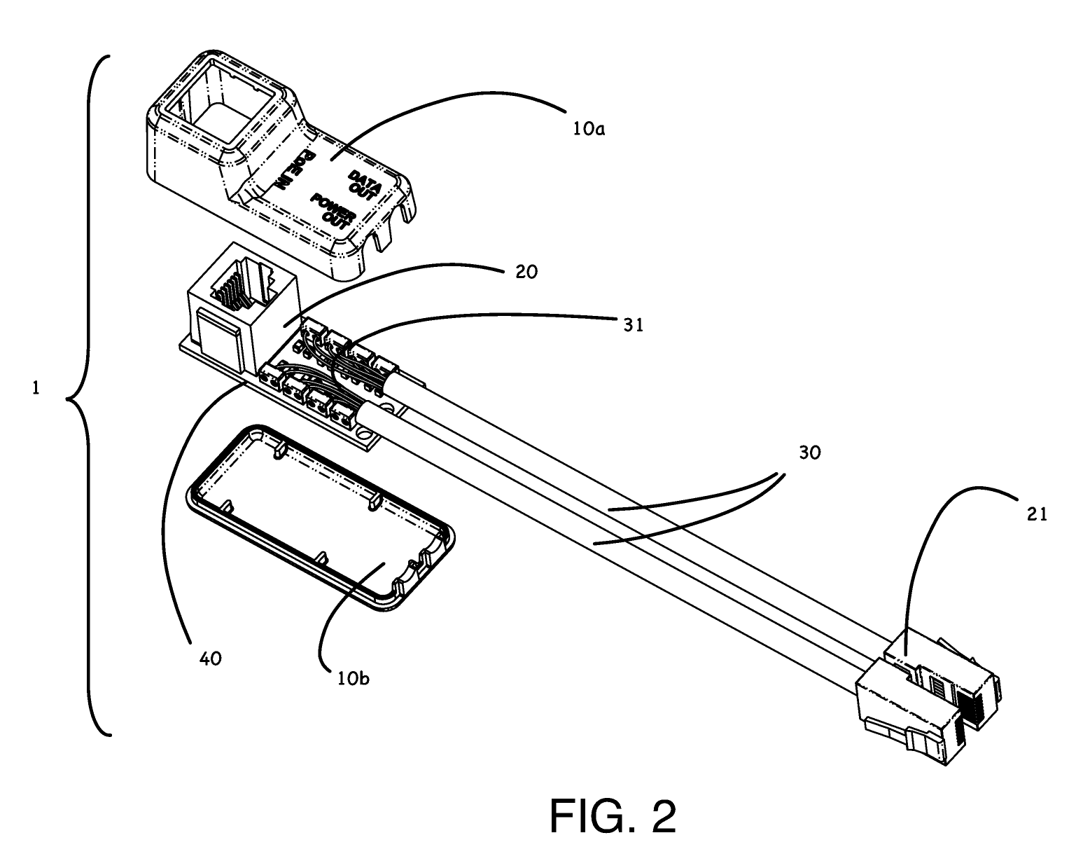

FIG. 2 shows an exploded perspective view of the electronic system 1. The housing 10 may be any form of housing that contains the printed circuit board assembly 40, which can also be referred to as a splitter circuit 40. As shown, the housing top 10a and housing bottom 10b can be formed together using any method as snap in or use of an adhesive. The connector port RJ45 socket 20 may be any termination of individual wires of an Ethernet cable by a conductive contact to the printed circuit board assembly 40. The RJ45 plug 21 may be a connector for Ethernet cable connecting to another electronic circuit or electronic device. The RJ45 plug 21 can terminate the individual wires of an Ethernet cable 31 from an Ethernet cables carrying PoE 30.

As shown in FIG. 2, the electronic system 1 includes a splitter circuit 40 located along an internal portion of the housing 10. The splitter circuit 40 can be arranged and configured to receive the data and the power from the Ethernet cable and thereby split the data from the power.

The splitter circuit 40 includes at least one capacitor 43 arranged and configured to block power, and an electrical component 44, such as a ferrite bead, having an impedance arranged and configured to block data.

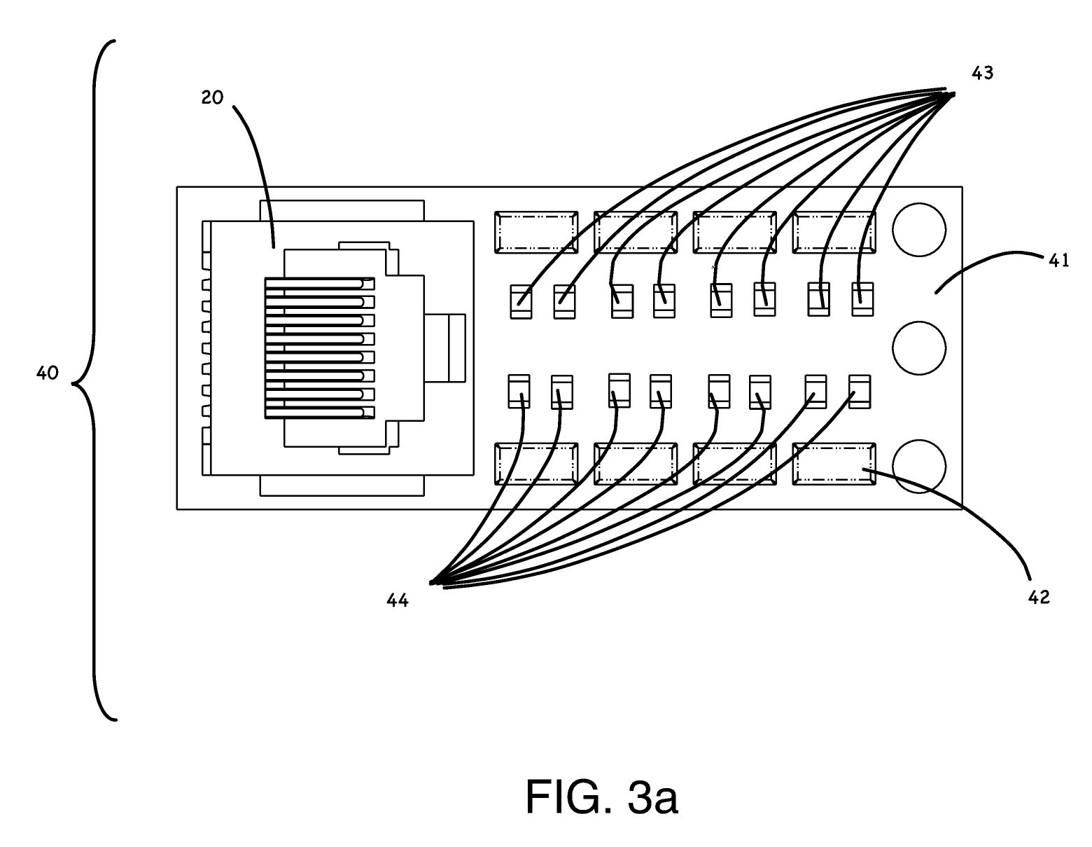

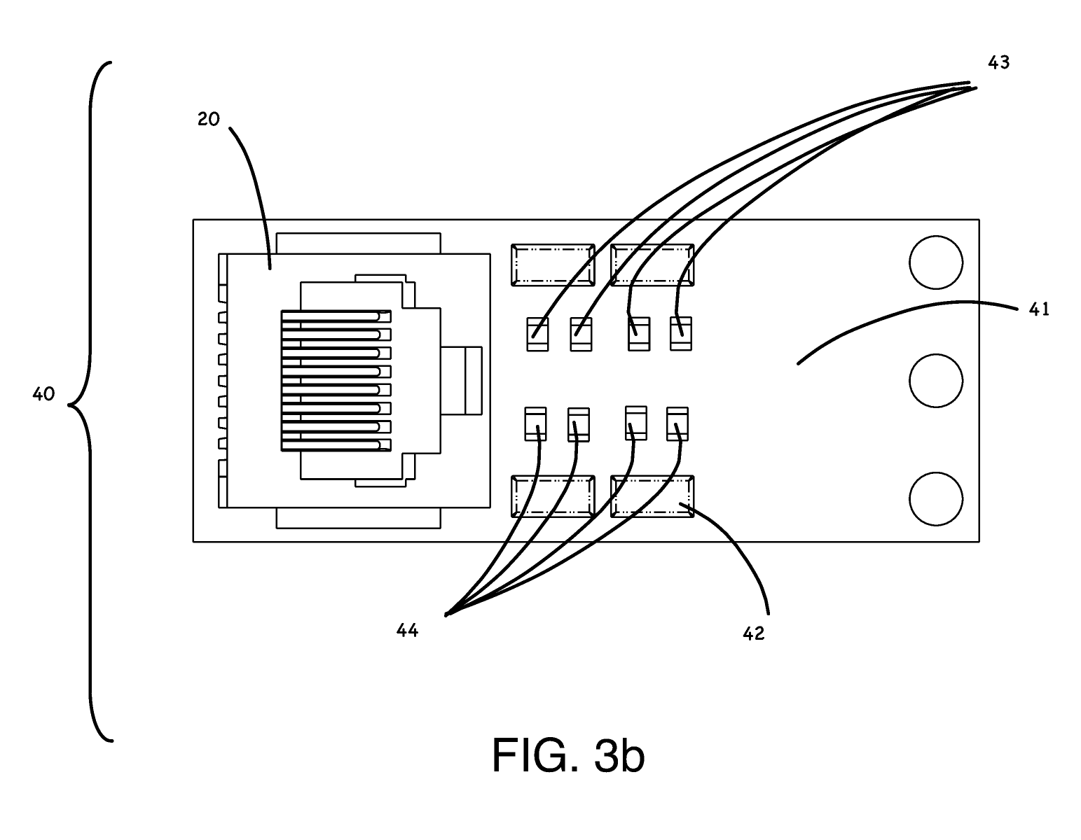

FIG. 3a illustrates a top view of the PCB assembly 40 inside the housing of the PoE cable splitter 1 highlighting the various components on the PCB assembly 40. The PCB assembly 40 can contain a connector port RJ45 socket 20, a PCB substrate, insulation displacement connectors (IDC's) 42, capacitors 43, and ferrite beads 44 in any configuration. The IDC's 42 terminate the individual wires of an Ethernet cable 31 from an Ethernet cable to the PCB assembly 40. The individual wires of an Ethernet cable 31 from an Ethernet cable may be terminated to the PCB assembly 40 by any conductive contact such as soldering or the wire looping around a conductive pin.

FIG. 3b illustrates another embodiment of the PCB assembly 40 that accommodates only for Mode A PoE on Ethernet cables. This set up is simply a reduced functionality configuration of the PCB assembly shown in FIG. 3a.

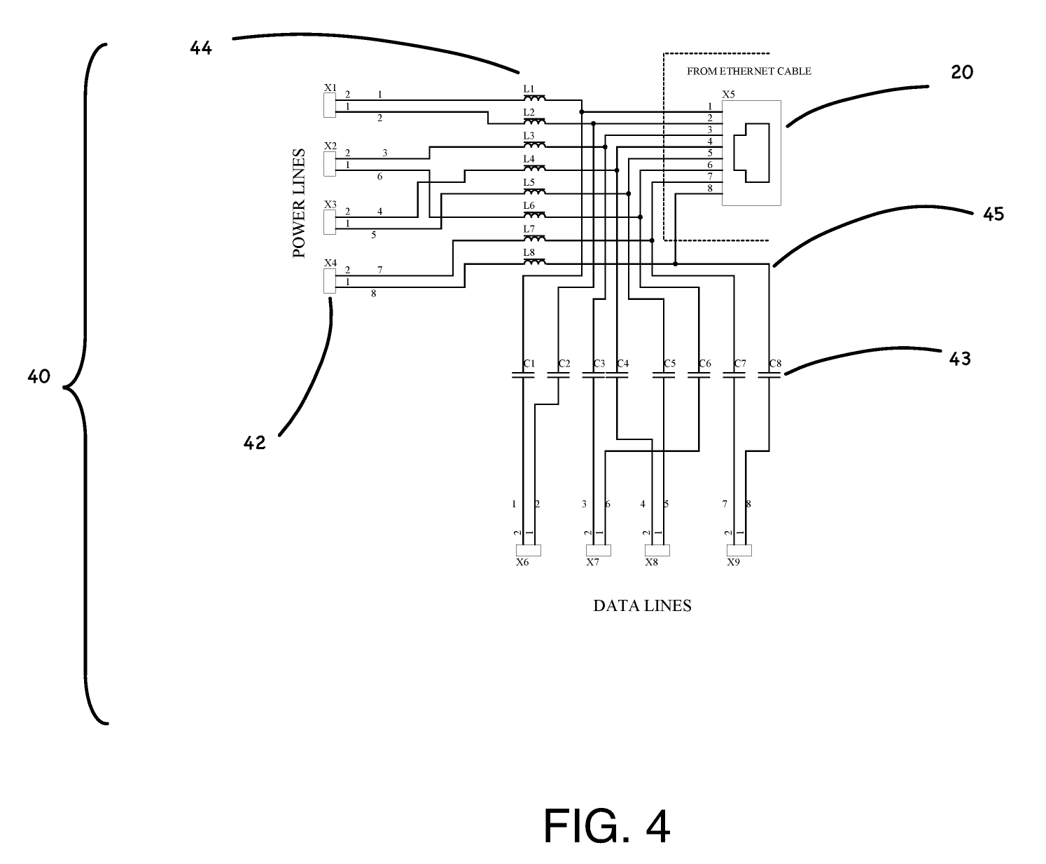

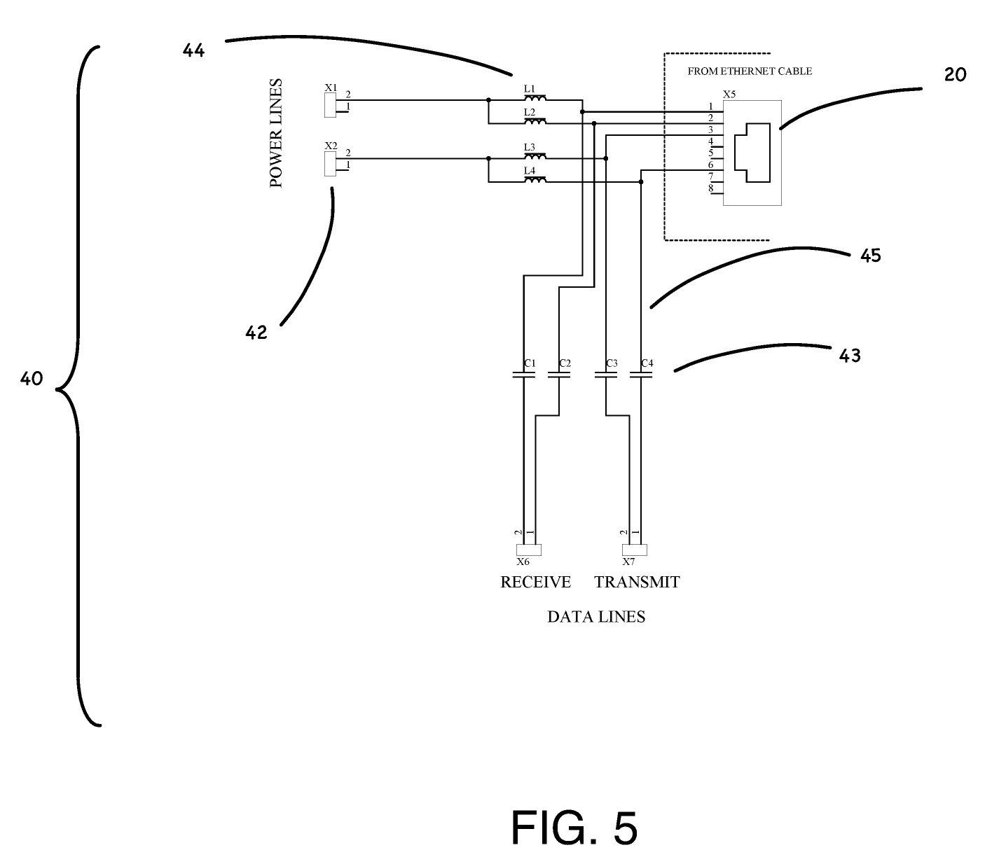

Shown in FIGS. 4 and 5 are schematics of the electric circuit of the PCB assembly. Power and data signal travel from the connector port RJ45 socket 20 and running along the PCB traces 45. The PCB traces 45 split to reach the capacitors 43 and ferrite beads 44 separately. Finally, all the PCB traces 45 can terminate to the IDC's 42.

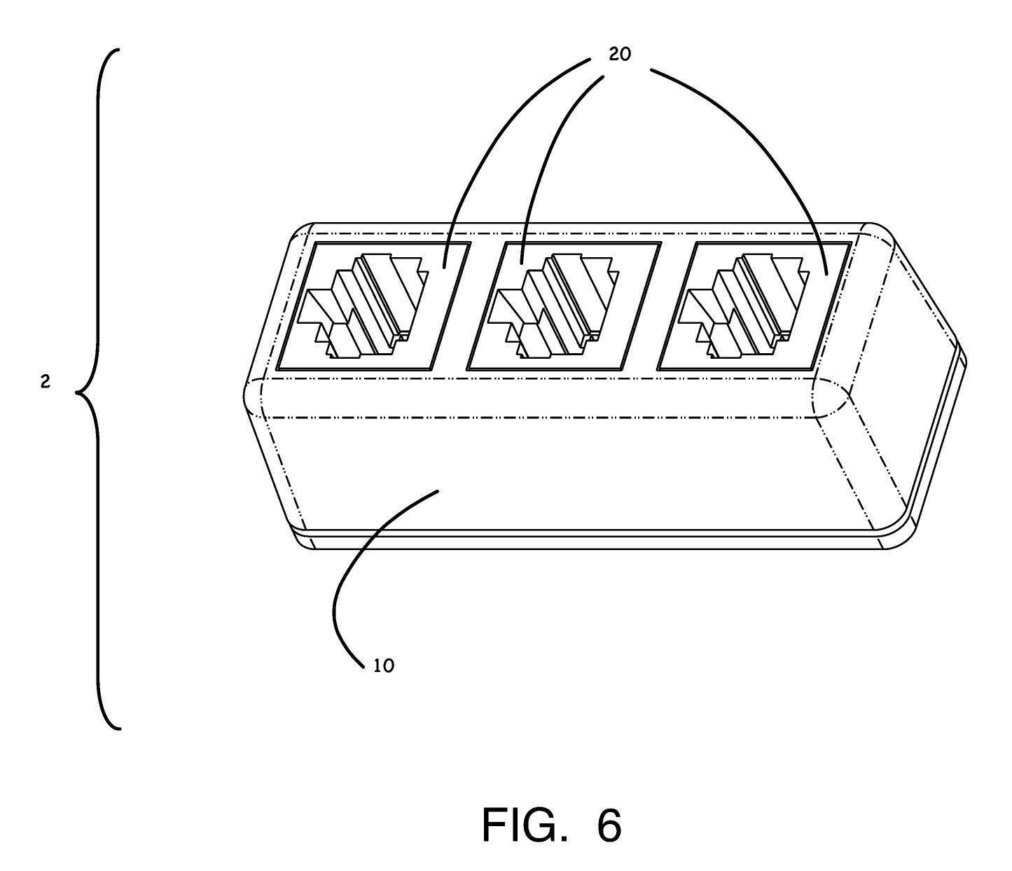

FIG. 6 illustrates another embodiment of the PoE cable splitter 2. This embodiment implements RJ45 sockets 30 instead of Ethernet cables 30 with RJ45 plugs 21 in order to provide data and power on separate sockets. It should be appreciated that the housing 10 can be constructed of any material.

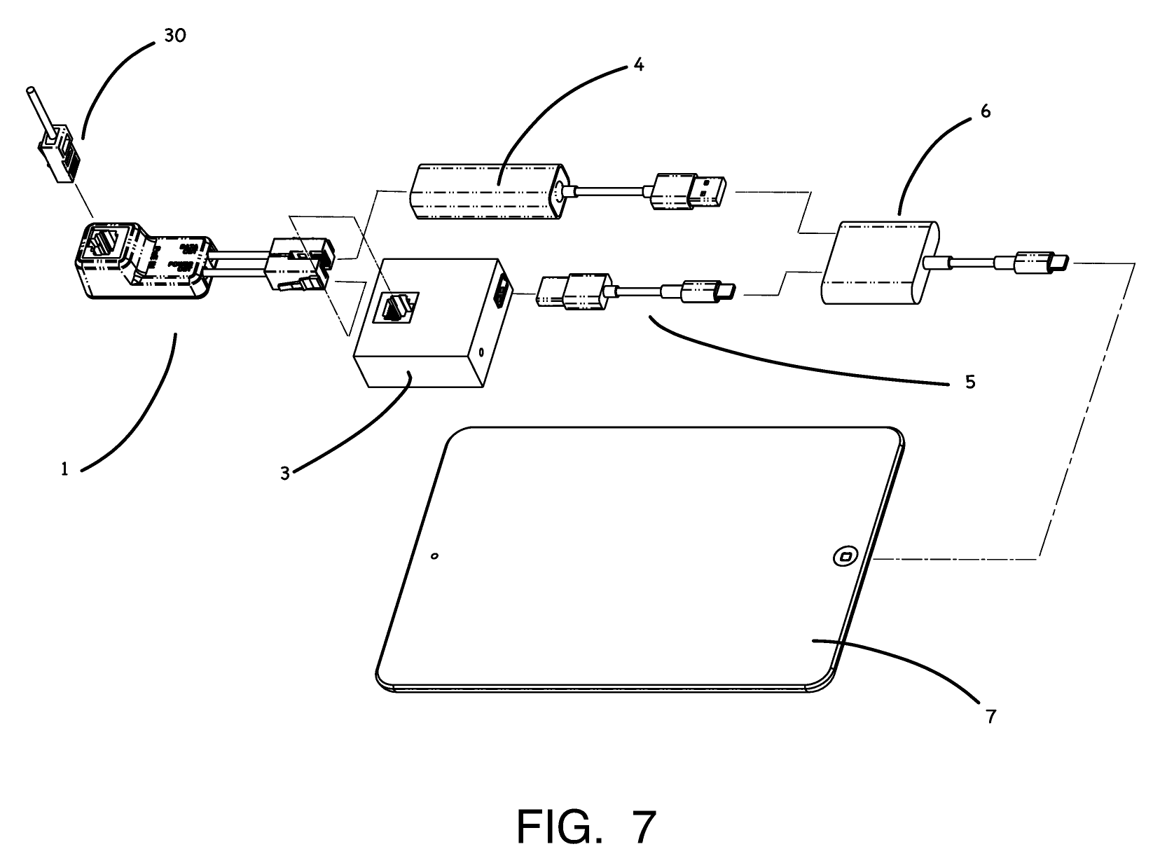

Shown in FIG. 7 is the overview layout of one way of using the PoE cable splitter 1 to connect an Ethernet cable 30 with PoE to a lightning connector socket in a tablet device 7, such as an iPad 7. The RJ45 Plug from the Ethernet cable 30 can connect to the PoE cable splitter 1 by an RJ45 socket 4. The power can thereby be transmitted out of the PoE cable splitter 1 and connected to the Kronos PCBA 3 by an RJ45 socket. The USB to Lightning cable 5 can thereby be connected to the Kronos PCBA 3 by a USB socket. The USB to Lightning cable 5 can be connected to the camera adapter 6 by a lightning connector. Data can thereby be transmitted out of the PoE cable splitter 1 and connected to the RJ45 Socket to USB Plug cable 4 by the RJ45 socket. The RJ45 Socket to USB Plug cable 4 is connected to the camera adapter 6 by a USB plug. The camera adapter 6 is connected to the tablet device 7 by a lightning connector socket on the tablet device 7.

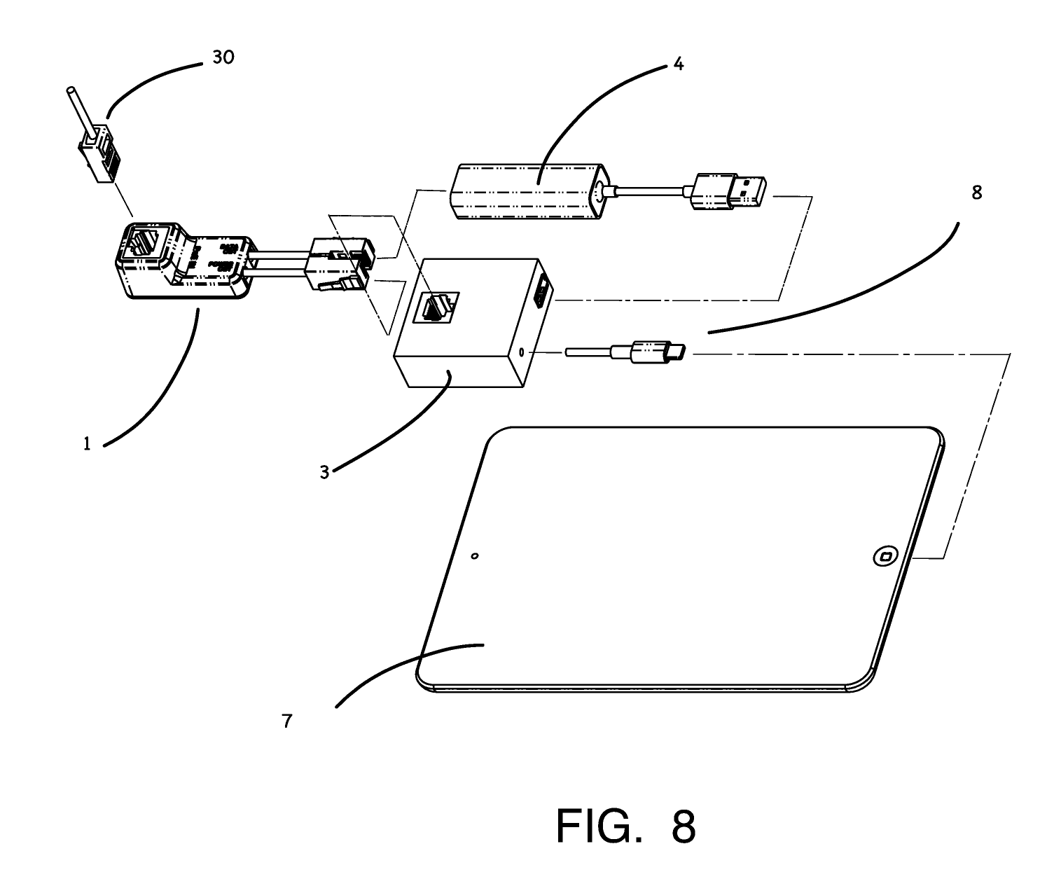

FIG. 8 shows an overview layout of one way of using the PoE cable splitter 1 to connect an Ethernet cable with PoE 30 to a USB connector socket in a tablet device 7. The RJ45 Plug from the Ethernet cable 30 may connect to the PoE cable splitter 1 by a RJ45 socket. The power can be transmitted out of the PoE cable splitter 1 and connected to the PCBA 3 by a RJ45 socket. The USB to Lightning cable 5 is connected to the PCBA 3 by a USB socket. A cable from the PCBA 3 5 can be connected to the USB connector socket in the tablet device 7 by a USB plug.

Generally speaking, the disclosure includes an electronic assembly that receives power and data on individual wires. The standard Ethernet cable, either FTP or UTP, can be constructed from 4 twisted pairs, numbered 1 to 4. 10/100 MB/s use pairs 1 and 2 for data transfer. PoE mode A uses the same pairs 1 and 2 to transfer DC power, with pair 1 being used as one of the poles of the DC power and pair 2 is used for the opposite pole. The unused pairs 3 and 4 for the 10/100 MB/s networks are used for power delivery in power mode B. Because the 1000 MB/s (1 GB/s) use the pairs 1,2,3 and 4 for data transfer this splitter allows operation with devices who support 1 GB/s networks and PoE of a Ethernet cable via PoE technology alternative A or alternative B. Generally, the electronic systems 1, 2 disclosed can support both modes A and B simultaneously and each mode separately (individually) and to split the Data from the DC power for 10/100/1000 MB/s networks and split the data signal to one wire and the DC power into another wire. Furthermore, embodiments of the electronic system 1, 2 may be passive and not require an external power source.

### Power and Data Splitting Methods

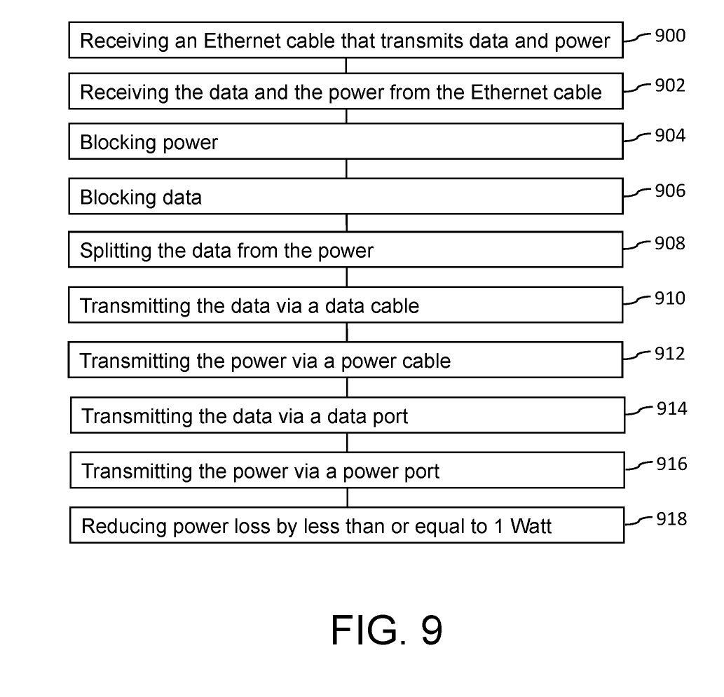

The disclosure also includes methods of using an electronic system 1, 2 to receive data and power from an Ethernet cable and split the data and the power. As shown in FIG. 9, methods include receiving, via an input port 20 coupled to a housing 10, the Ethernet cable that transmits the data and the power (at step 900). Methods can also include receiving, via a splitter circuit 40 located within an internal portion of the housing 10, the data and the power from the Ethernet cable (at step 902). Even still, methods can include blocking power, via at least one capacitor 43 located along the splitter circuit 40 (at step 904); and blocking data, via an electrical component 44 located along the splitter circuit 40 (at step 906).

In some embodiments, the method includes splitting, via the splitter circuit 40, the data from the power (at step 908). Methods may also include transmitting, via a data cable 30 extending from the housing 10, the data (at step 910). Methods can even include transmitting, via a power cable 30 extending from the housing 10, the power (at step 912).

Even still, methods can include transmitting, via an output data port located on the housing 10, the data (at step 914). As well, methods can include transmitting, via an output power port located on the housing 10, the power (at step 916). In some embodiments, methods include reducing, via the electronic system 1, 2, power loss by less than or equal to 1 Watt. The reduction in power loss can be as compared to prior art splitting systems, such as the systems disclosed in the background section.

### Interpretation

None of the steps or limitations described herein is essential or indispensable. Any of the steps or limitations can be adjusted or modified. Other or additional steps and/or limitations can be used. Any portion of any of the steps, processes, structures, and/or devices disclosed or illustrated in one embodiment, flowchart, or example in this specification can be combined or used with or instead of any other portion of any of the steps, processes, structures, and/or devices disclosed or illustrated in a different embodiment, flowchart, or example. The embodiments and examples provided herein are not intended to be discrete and separate from each other.

The section headings and subheadings provided herein are nonlimiting. The section headings and subheadings do not represent or limit the full scope of the embodiments described in the sections to which the headings and subheadings pertain. For example, a section titled “Topic 1” may include embodiments that do not pertain to Topic 1 and embodiments described in other sections may apply to and be combined with embodiments described within the “Topic 1” section.

The various features and processes described above may be used independently of one another, or may be combined in various ways. All possible combinations and subcombinations are intended to fall within the scope of this disclosure. In addition, certain method, event, state, or process blocks may be omitted in some implementations. The methods, steps, and processes described herein are also not limited to any particular sequence, and the blocks, steps, or states relating thereto can be performed in other sequences that are appropriate. For example, described tasks or events may be performed in an order other than the order specifically disclosed. Multiple steps may be combined in a single block or state. The example tasks or events may be performed in serial, in parallel, or in some other manner. Tasks or events may be added to or removed from the disclosed example embodiments. The example systems and components described herein may be configured differently than described. For example, elements may be added to, removed from, or rearranged compared to the disclosed example embodiments.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations and so forth. Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require at least one of X, at least one of Y, and at least one of Z to each be present.

The term “and/or” means that “and” applies to some embodiments and “or” applies to some embodiments. Thus, A, B, and/or C can be replaced with A, B, and C written in one sentence and A, B, or C written in another sentence. A, B, and/or C means that some embodiments can include A and B, some embodiments can include A and C, some embodiments can include B and C, some embodiments can only include A, some embodiments can include only B, some embodiments can include only C, and some embodiments can include A, B, and C. The term “and/or” is used to avoid unnecessary redundancy.

While certain example embodiments have been described, these embodiments have been presented by way of example only, and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions, and changes in the form of the methods and systems described herein may be made without departing from the spirit of the inventions disclosed herein.

The following is claimed:

1. An electronic system that receives data and power from an Ethernet cable and splits the data and the power, comprising:
a housing;
an input port coupled to the housing, the input port arranged and configured to receive the Ethernet cable that transmits the data and the power; and
a splitter circuit located along an internal portion of the housing, the splitter circuit arranged and configured to receive the data and the power from the Ethernet cable and thereby split the data from the power,
wherein the splitter circuit includes at least one capacitor arranged and configured to block power; and an electrical component having an impedance arranged and configured to block data.

2. The electronic system of claim 1, wherein the electrical component comprises at least one of a ferrite bead and an inductor, the electronic system further comprising:
at least one of an output data port located on the housing and a data cable extending from the housing, the at least one of the output data port and the data cable arranged and configured to receive the data from the splitter circuit and thereby transmit the data; and
at least one of an output power port located on the housing and a power cable extending from the housing, the at least one of the output power port and the power cable arranged and configured to receive the power from the splitter circuit and thereby transmit the power.

3. The electronic system of claim 2, wherein the at least one of the output data port and the data cable comprises the data cable, and wherein the at least one of the output power port and the power cable comprises the power cable.

4. The electronic system of claim 3, wherein the input port defines an RJ45 type socket, the data cable including a first output RJ45 plug located opposite the housing, the electronic system further comprising a data adapter cable including a first end having an RJ45 socket that receives the data from the first output RJ45 plug and a second end having a cable with a USB plug that transmits the data.

5. The electronic system of claim 4, wherein the power cable defines an Ethernet type cable, the power cable including a second output RJ45 plug located opposite the housing, the electronic system further comprising a power adapter device including a first side having an RJ45 socket that receives the power from the second output RJ45 plug and a second side having a USB socket that transmits the power.

6. The electronic system of claim 5, further comprising a power adapter cable including a first end having a USB plug that receives the power and a second end having a lightning cable plug that transmits the power.

7. The electronic system of claim 6, further comprising a data and power adapter cable including a first end having a USB socket that receives data from the USB plug of the data adapter cable, and a lightning cable socket that receives power from the lightning cable plug of the power adapter cable, the data and power adapter cable including a second end having a lightning cable plug that transmits the data and power to a tablet device.

8. The electronic system of claim 7, wherein both the first cable and the second cable are disposed within a cable sheath.

9. The electronic system of claim 2, wherein the at least one of the output data port and the data cable comprises the output data port, and wherein the at least one of the output power port and the power cable comprises the output power port.

10. The electronic system of claim 9, wherein the input port defines an RJ45 type socket, the output data port defines an RJ45 type socket, and the output power port defines an RJ45 type socket.

11. The electronic system of claim 10, further comprising:
a data cable extending from the output data port, the data cable arranged and configured to receive the data from the splitter circuit and thereby transmit the data; and
a power cable extending from the output power port, the power cable arranged and configured to receive the power from the splitter circuit and thereby transmit the power.

12. The electronic system of claim 11, wherein the data cable includes a first end comprising a first output RJ45 plug and a second end comprising a first input RJ45 plug electrically and mechanically coupled to the output data port, and wherein the power cable includes a first end comprising a second output RJ45 plug and a second end comprising a second input RJ45 plug electrically and mechanically coupled to the output power port.

13. The electronic system of claim 12, further comprising:
a data adapter cable including a first end comprising an RJ45 socket that receives the data from the first output RJ45 plug and a second end having a cable with a USB plug that transmits the data; and
a power adapter device including a first side having an input RJ45 socket that receives the power from the second output RJ45 plug and a second side having a USB socket that transmits the power.

14. The electronic system of claim 13, further comprising:
a power adapter cable including a first end having a USB plug that receives the power and a second end having a lightning cable plug that transmits the power; and
a data and power adapter cable including a first end having a USB socket that receives data from the USB plug of the data adapter cable, and a lightning cable socket that receives power from the lightning cable plug of the power adapter cable, the data and power adapter cable including a second end having a lightning cable plug that transmits the data and power to a tablet device.

15. The electronic system of claim 2, wherein the input port is located on the housing.

16. A method of using an electronic system to receive data and power from an Ethernet cable and split the data and the power, the method comprising:
receiving, via an input port coupled to a housing, the Ethernet cable that transmits the data and the power;
receiving, via a splitter circuit located within an internal portion of the housing, the data and the power from the Ethernet cable;
blocking power, via at least one capacitor located along the splitter circuit; and
blocking data, via an electrical component located along the splitter circuit, the electrical component having an impedance.

17. The method of claim 16, further comprising splitting, via the splitter circuit, the data from the power.

18. The method of claim 17, further comprising:
transmitting, via a data cable extending from the housing, the data; and
transmitting, via a power cable extending from the housing, the power.

19. The method of claim 17, further comprising:
transmitting, via an output data port located on the housing, the data; and
transmitting, via an output power port located on the housing, the power.

20. The method of claim 16, further comprising reducing, via the electronic system, power loss by less than or equal to 1 Watt.
